(19) United States
(12) Patent Application Publication
(10) Pub. No.: US 2003/0196105 A1
(43) Pub. Date: Oct. 16, 2003

(54) Remote access VPN extranets

(76) Inventor: Victoria Fineberg, Red Bank, NJ (US)

Correspondence Address: John E. Curtin Esq., Troutman Sanders LLP, 1660 Inetrnational Dr., Suite 600, McLean, VA, 22102, US

(21) Appl. No.: 10/121,188

(22) Filed: Apr. 12, 2002

(51) Int. Cl. H04L 9/00

(52) U.S. Cl. 713/200; 713/168

(57) ABSTRACT

The present invention provides a system and method for connecting a Remote User of a first company to an extranet of a second company. In an exemplary embodiment of the present invention, the Remote User is routed through a Universal Mobile Telecommunications Service (UMTS) network to an Internet Service Provider (ISP) associated with the second company. The ISP then routes the communication to the second company's extranet. The UMTS communicates with the Remote User through the UMTS' SGSNs (Serving GPRS Support Nodes). The SGSN routes the user traffic to a GGSN (Gateway GPRS Support Node) associated with the user's company. The GGSN authenticates the user and routes the user traffic flows through the second company's ISP to the second company's extranet. In an exemplary embodiment of the present invention, the first and second companies both use the same UMTS. Accordingly, the UMTS is able to authenticate users from both the first and second companies and direct communication between the Remote User and the desired first or second company.

### TECHNICAL FIELD

This invention relates generally to computer and networking systems, and more particularly to a system and method for providing wireless remote access to an extranet.

### BACKGROUND OF THE INVENTION

As the world has become more interconnected and companies have taken greater advantage of world-wide communications resources, such as the Internet, companies have started working more closely together to share resources. As a result of the attempts to share resources and to streamline the inter-company information exchange, many companies open up certain portions of their computer, database, and network resources to other companies. Often these companies work together in joint ventures and need to share common information. Furthermore, direct exchange of information is frequently necessary for streamlining supplier-customer relationships, e.g., for placing orders, verifying company-specific price-lists and discounts, tracking orders, and many other functions.

In today's age of large-scale computer networks, most companies have a VPN (Virtual Private Network) which links each of its employees to common corporate resources. VPNs that serve a specific single company are referred to as intranets. VPN intranets belong to two general categories:

(1) remote access VPN intranets, where employees access company resources remotely, using remote access such as modem dial up, ISDN, xDSL, cable modem, wireless, etc., and all necessary authentication, gateway, firewall and other nodes, and

(2) site-to-site VPN intranets, where employees have access to company resources at various company sites by the virtue of being authenticated at a given site (e.g., by remote access to this site or by being on this site's LAN).

When a company shares a portion of its computer, database and network resources with another company, this network is referred to as a VPN extranet. An extranet is a network that is shared by two or more otherwise independent companies. When a user that belongs to Company A (User 1) (usually an employee of Company A) wishes to connect to the extranet of Company B, User 1 must first log into the network, or intranet, for Company A and then, through that intranet, connect to Company B. The present state of art—prior to the invention described herein—is that VPN extranets operate strictly on the site-to-site basis. The process of sending data from User 1 through the intranet of Company A to Company B adds delay, utilizes extensive network resources, and slows down network communications. This is especially true when User 1 connects from a remote location.

Therefore, it is evident that there is a need in the art for systems and methods for remotely connecting to an extranet without first connecting to the user's base intranet.

### SUMMARY OF THE INVENTION

The present invention overcomes the limitations of the existing technology by providing systems and methods for remotely connecting to an extranet without first connecting to the user's base intranet. This is accomplished by providing a Remote User with a direct connection to an extranet.

The present invention connects a Remote User to an extranet by routing the Remote User through a Universal Mobile Telecommunications Service (UMTS) or other advanced wireless network to an Internet Service Provider (ISP) and then to the destination company's (“Company B”) extranet.

The present invention applies specifically to the network portion of a wireless network. It is described with the reference to UMTS networks, but it can be extended to all advanced wireless networks that provide access to the Internet, including GPRS (General Packet Radio Service), CDMA2000, and others.

In UMTS networks, a wireless user is served by a network node called SGSN (Serving GPRS Support Node). The SGSN routes the user traffic to a GGSN (Gateway GPRS Support Node) over the network portion of the UMTS network. The GGSN, serving as a gateway to the global networks, authenticates the users and routes their traffic flows to the Internet, towards the destination company's ISP and the destination company's network. In this architecture—typical for all advanced wireless networks—different SGSNs are used depending on the user location, whereas a GGSN is associated with a specific company. As a user changes his or her location, every corresponding SGSN tunnels traffic to the specific GGSN, using GTP (GPRS Tunnelling Protocol).

Thus, all company's traffic converges at the GGSN, and a remote access VPN extranet service can be provided.

Other objects, features, and advantages of the present invention will become apparent upon reading the following detailed description of the embodiments of the invention, when taken in conjunction with the accompanying drawings and appended claims.

### BRIEF DESCRIPTION OF THE DRAWINGS

FIG. 1 is a remote access VPN extranet according to an exemplary embodiment of the present invention.

FIG. 2 is a remote access VPN extranet using a data center according to an exemplary embodiment of the present invention.

FIG. 3 is a flow diagram depicting an exemplary process of connecting a remote user to an extranet according to an exemplary embodiment of the present invention.

### DETAILED DESCRIPTION

Referring now to the drawings, in which like numerals refer to like parts or actions throughout the several views, exemplary embodiments of the present invention are described.

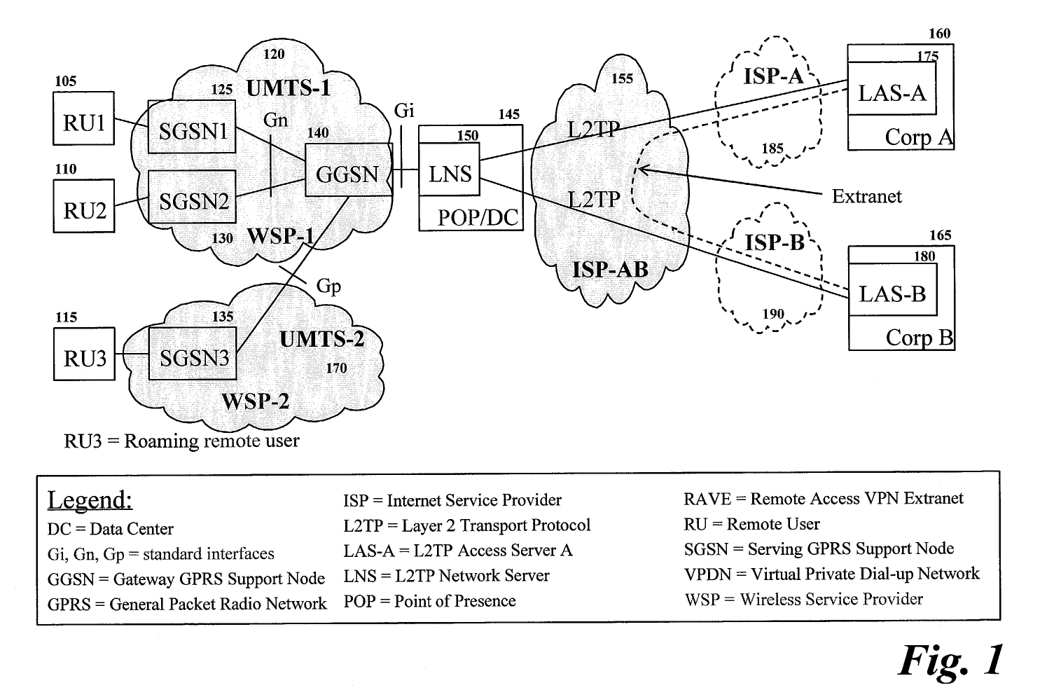

FIG. 1 is a remote access VPN extranet according to an exemplary embodiment of the present invention. The illustrated system operates on a wireless network architecture based on the GPRS core network. Examples of such networks include, but are not limited to, 2.5G GPRS and 3G UMTS networks. Those skilled in the art will recognize that CDMA2000, another major type of a 3G wireless network, has a slightly different core architecture, but all of the main principles of the present invention may be applied. These networks are preferable because they include certain features that can be taken advantage of by the present invention.

Any wireless network can be considered as consisting of two general parts:

(1) the air interface, i.e., the use of the electromagnetic spectrum for the over-the-air communications between a tetherless device (e.g., a cellular telephone, a wireless laptop, a wireless Personal Digital Assistant, etc) and all related circuitry in the user device and network-based base stations (e.g., Node-B in the UMTS networks) and their controllers; and

(2) the network portion that connects base stations to the rest of the network resources (e.g., switches, routers, gateways) and provides access to the global networks (e.g., the Internet)

Several features of the preferred networks include the following:

1. For each corporate user, there is always a single GGSN node that provides access to the wired Internet towards the corporate network;

2. As a user moves around, the user's traffic is accepted by an SGSN which changes as the user location changes, but a current SGSN always tunnels user traffic to the corporation's GGSN to be passed to the Internet. The significance of this is that all employees of the same corporation are served by the same GGSN regardless of where they access the network. Thus, they can be authenticated by a single UMTS Wireless Service Provider (WSP); and

3. UMTS networks use GTP, which provides connectivity between SGSNs and the GGSN, thus ensuring that regardless of where the user accesses the network, the business-related traffic is always tunneled to the specific GGSN.

As the GGSN is a gateway for the data traffic between the wireless network and the Internet, the WSPs have interoperability agreements with ISPs that route traffic from the GGSN to the global Internet. A single WSP may have one or more GGSNs and one or more ISP agreements. The selection of the GGSN to serve any given company will be based, among other things, on the efficiency of service provided via this WSP-associated ISP. In some scenarios, the ISP interworking with the WSP at the GGSN may also be providing the ISP services to the company itself. This eliminates the need for “ISP-A” and/or “ISP-B” and serves these companies by a common ISP-AB that is also an ISP that serves the WSP's GGSN associated with the companies A and B.

Throughout the specification, the users, devices, and networks described in conjunction with the present invention are referred to as being associated with a company or corporation. Those skilled in the art will recognize that the invention is not limited to companies and corporations, but applies equally to all entities. The present invention is intended to operate in an environment that allows multiple entities to share resources. An entity may be a company, a corporation, a division of a company, or other similar organization.

FIG. 1 shows a plurality of remote users, Remote User 1 (RU1) 105, Remote User 2 (RU2) 110 and roaming Remote User 3 (RU3) 115. Let us assume that RU1 and RU3 are employees of Corp. A, whereas RU2 is an employee of Corp. B. Employees of Corporation A and Corporation B may be referred to as being users of a first class or a second class. Classes of users refers to users of differing entities or having differing levels of access within a single entity. According to an exemplary embodiment of the present invention, the remote users 1 and 2 (105, 110) may connect to the UMTS network 120 directly, through the SGSN1 and SGNS2 (125 and 130), respectively. GTP is used between the SGSNs 1 and 2 (125 and 130) and the GGSN 140 via the interface Gn defined in the UMTS standards. The roaming Remote User 3 (115) may connect to the UMTS network 170 that belongs to another WSP, through the SGSN3 (135). In the latter case, GTP is used in the inter-WSP architecture, via the interface Gp defined in the UMTS standards, and it also tunnels user traffic to the target GGSN.

The UMTS may be provided by a variety of wireless service providers. Such UMTS WSPs may include, but are not limited to, AT&T Wireless, VoiceStream (Deutsche Telecom), NTT DoCoMo (Japan), Telefónica (Spain), BT (UK), or other wireless communications providers. (A variety of other WSPs support the CDMA2000 network architecture that also is subject to the present invention. CDMA2000 providers include Verizon Wireless, Sprint PCS and others.) In an exemplary embodiment of the present invention, it is preferable that each company providing VPN extranet capabilities to the employees of another company use the same UMTS 120 provider and the same GGSN 140. This allows the UMTS 120 WSP to authenticate the users of each company without passing the traffic to the user's VPN intranet first. Eliminating this additional step increases network efficiency and significantly improves the user experience.

The authentication of each user is performed in the UMTS 120 by a GGSN 140. The GGSN acts as a gateway between the UMTS network and global Internet or other public or private data networks. GGSNs maintain routing information that is necessary to tunnel the protocol data units (PDUs) to the SGSNs that service particular Remote User devices. Other functions include network and subscriber screening and address mapping.

The GGSN 140 directs the signal to a network access server. In an exemplary embodiment of the present invention, an L2TP (Layer 2 Tunnelling Protocol) Network Server (LNS) 150 may be used as the network access server. Other tunnelling methods may include, but are not limited to, PPTP (Point to Point Tunnelling Protocol), GRE (Generic Routing Encapsulation), IPSec (IP Security), and others.

The LNS 150 is generally located in an ISP's POP (Point of Presence) 145 and handles the authentication of the user traffic to a corporate server and then tunnels traffic to the LAS (L2TP Access Server) on company premises. In the general case of the L2TP operation prior to the present invention, the LNS was provided by the ISP serving the specific user, and it had to communicate with the corporate servers via the global Internet and the ISP serving the corporation. Using the present invention, the plurality of the ISPs serving various remote users is replaced with a single ISP that is serving the GGSN associated with the corporation. Thus a single LNS 150 is responsible for authenticating Remote User 1 105 to Corporation A's network 160.

The same LNS 150 can also authenticate Remote User 1 105 to Corporation B's network 165, and authenticate Remote User 2 110 to Corporation A's network 160, thus creating remote access VPN extranets.

This cross-authentication functionality may reside in the LNS that belongs to the WSP, in the GGSN, or in some GGSN adjunct server. In any case, it enables the WSP to offer a new service, remote access VPN extranet.

In an exemplary embodiment of the present invention, the system may accommodate a roaming Remote User 115 from Company A 160 and authenticate him or her to the VPN extranet of Company B 165. In this scenario, the roaming Remote User 115 may connect to a second UMTS 170 that is different from the UMTS 120 utilized by Companies A 160 and B 165. The SGSN3 135 of the second UMTS 170 directs user traffic to the GGSN 140 of the UMTS 120 utilized by Companies A 160 and B 165. When the communication signal path gets to the GGSN 140 of the UMTS 120, the remainder of the communication to the intranets and extranets of Companies A 160 and B 165 are identical to the communication path described above.

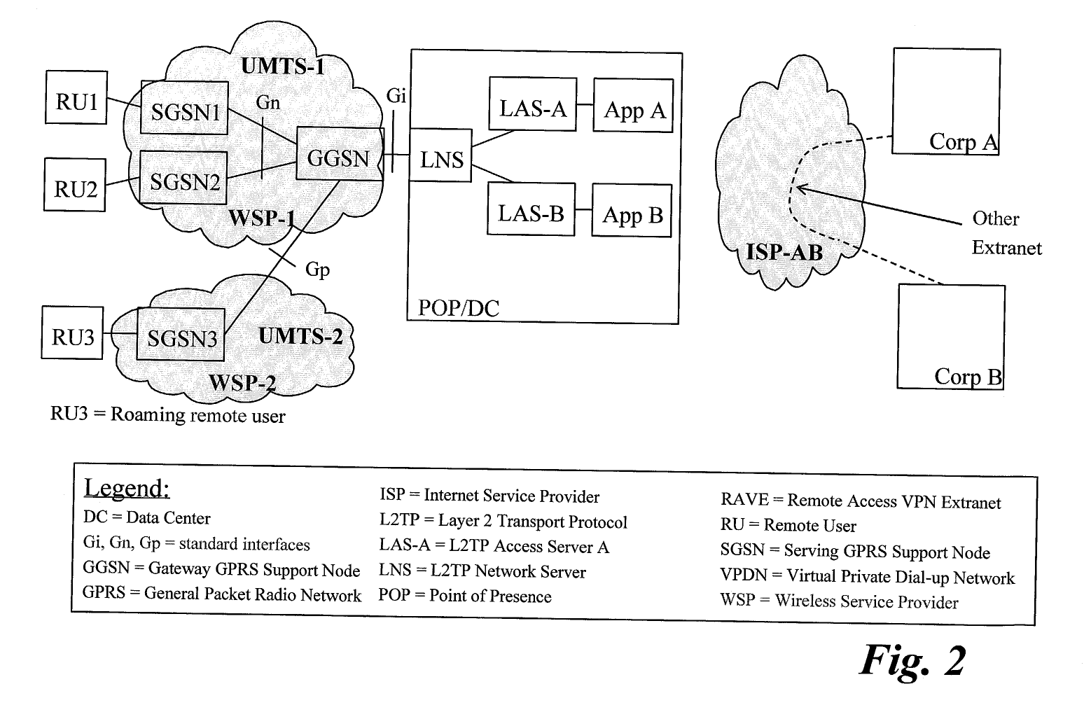

FIG. 2 is a remote access VPN extranet using a data center according to an exemplary embodiment of the present invention. FIG. 2 illustrates an alternative embodiment of the present invention similar to the exemplary embodiment illustrated in FIG. 1. FIG. 2 shows the same components as FIG. 1. Accordingly, the description of each component of FIG. 2 will not be repeated. FIG. 2 shows a system architecture that may be preferable when: (1) the same service provider serves two companies; and (2) the service provider has a data center that hosts servers from both companies. When these two elements are present, the extranet connectivity may not need to go through ISP WAN networks, but may be provided in the LAN of the data center itself. As described above, the extranet is a subset of nodes (usually servers and/or specific applications on these servers) that one company opens to other companies. Depending on the company size, the extranet may include one server or hundreds of nodes. Typically, only the extranet servers located in the service provider's data center may be directly connected via the data center LAN, but they may comprise all (or most) of the extranet connectivity.

The wireless remote access architecture discussed in conjunction with FIG. 1 makes this arrangement more efficient. Without the remote access VPN extranet, the remote access and the ISP data center hosting may be decoupled. The LAS nodes could be located in the company premises and the extranet nodes could be in the data center. The user traffic would trace several networks to get to the company site-based servers for authentication and access and then be routed to the ISP data center for the access to the intranet/extranet applications. With the remote access VPN extranet described in the present invention, a remote VPN extranet user is authenticated to the extranet in the GGSN or its adjunct. If the GGSN is directly connected to a WSP's data center (or even located in the data center), then the remote user may access the extranet immediately (over the data center LAN) without having to trace an ISP network.

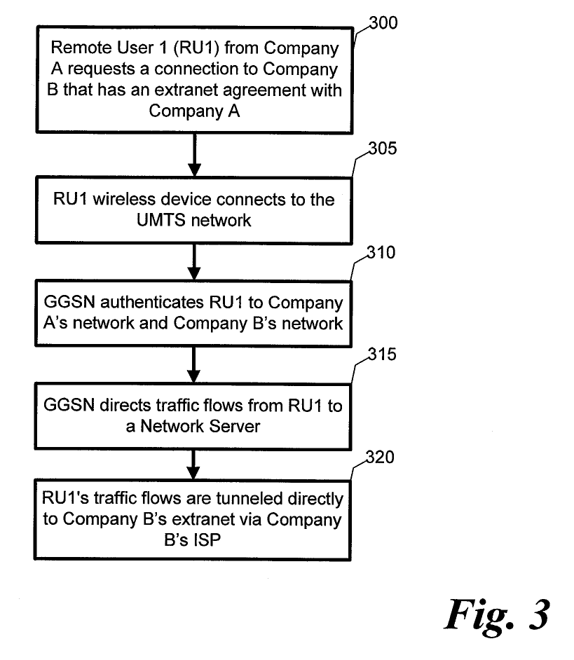

FIG. 3 is a flow diagram depicting an exemplary process of connecting a remote user to an extranet. In an exemplary embodiment of the present invention, Remote User 1 105 from Company A 160 may connect to the extranet of Company B 165 by requesting connection to Company B's 165 extranet without passing through Company A's 160 intranet.

In order to connect to Company B's 165 extranet, Remote User 1 105 first issues a request to connect to Company B's 165 extranet, 300. This is ordinarily done by issuing a command, or activating an icon, or using some other method such as voice recognition, on an electronic device such as a computer, laptop, PDA or an advanced cellular phone. Once Remote User 1 105 requests connection to Company B's 165 extranet 300, User 1's 105 remote device connects to Company A's UMTS 120, 305. Those skilled in the art are familiar with various methods and means for connecting a 10 user device to a WSP.

After the Remote User 1 105 device connects to the UMTS 120, the GGSN 140 in the UMTS 120 authenticates Remote User 1 105 to its company's network 160, and to Company B's extranet 310 (this authentication functionality may be handled by the is GGSN itself or by an LNS or another adjunct device, as described above). In an exemplary embodiment of the present invention, Company A 160 and Company B 165 both use the same UMTS 120.

Accordingly, the UMTS 120 knows that Remote User 1 105 may access both Company A 160 (Company A's intranet) and Company B 165 (Company B's extranet). In this manner, the UMTS 120 can authenticate remote users from both Company A 160 and Company B 165. Therefore, the UMTS 120 can authenticate Remote User 1 105 of Company A 160 to access an appropriate part of the Company B's 165 network (extranet); and the UMTS 120 can authenticate Remote User 2 110 of Company B 165 to access an appropriate part of the Company A's 160 network (extranet) 310.

After Remote User 1 105 has been authenticated, the GGSN 140 directs traffic flows from Remote User 1's 105 device to the L2TP Network Server (LNS) 150, 315. The LNS 150 then directs communication via the ISP 155 for Company B's L2TP Access Server (LAS) 180. In an exemplary embodiment of the present invention, both Company A 160 and Company B 165 share a common ISP 155 which is also the ISP serving the WSP at the GGSN 140.

Remote User 1 105 then connects to Company B's 165 extranet through Company B's 165 ISP 155, 320. Once the connection is established between User 1's 105 remote device and Company B's 165 extranet, Remote User 1 105 may conduct business through Company B's 165 extranet.

While this invention has been described in detail with particular reference to preferred embodiments thereof, it will be understood that variations and modifications can be effected within the scope of the invention as defined in the appended claims.

We claim:

1. A system for connecting a plurality of remote access devices to a plurality of networks, the system comprising:
a gateway node operative to:
communicate with a first entity network associated with a first ISP;
communicate with a second entity network associated with a second ISP;
communicate with a first serving node for authenticating a first remote device to communicate with the first and second entity networks; and
communicate with a second serving node for authenticating a second remote device to communicate with the first and second entity networks.

2. The system of claim 1, wherein the first remote device is associated with a first entity and the second remote device is associated with a second entity.

3. The system of claim 1, wherein the first and second ISPs are the same ISP.

4. The system of claim 1, wherein the first and second serving nodes are associated with a first UMTS provider.

5. The system of claim 4, wherein the gateway node is further operative to:
communicate with a third remote device associated with the first entity through a third serving node associated with a second UMTS network;
authenticate the third remote device; and
couple the third remote device to an extranet of the second entity network.

6. The system of claim 5, wherein the first remote device is associated with a first entity, the second remote device is associated with a second entity and the third remote device is associated with the first entity.

7. The system of claim 1, wherein the gateway node is further operative to connect the first remote device to the extranet of the second entity network in a data center associated with a wireless service provider associated with the first and second entity networks.

8. The system of claim 1, wherein the serving nodes tunnel communication traffic to the gateway node using GPRS tunneling protocol.

9. The system of claim 1, wherein each serving node is an SGSN.

10. The system of claim 1, wherein each gateway node is a GGSN.

11. A method for connecting remote access devices to a plurality of networks, comprising:
authenticating:
first class devices with respect to a first network;
second class devices with respect to a second network;
first class devices with respect to the second network; and
second class devices with respect to the first network.

12. The method of claim 11, further comprising:
communicating with a first serving node that services the first class devices; and
communicating with a second serving node that services the second class of devices.

13. The method of claim 12, wherein the first class of devices are associated with a first entity having the first network and the second class of devices are associated with a second entity having the second network.

14. The method of claim 13, further comprising connecting the first class of devices to an intranet of the first network and an extranet of the second network and connecting the second class of devices to an extranet of the first network and an intranet of the second network.

15. The method of claim 14, further comprising:
coupling authenticated devices to the respective networks.

16. Within an advanced wireless network, a method of connecting a remote access device associated with a first entity to an extranet associated with a second entity, said method comprising:
receiving from the first remote access device a request for a connection to the extranet;
authenticating the first remote device; and
connecting the authenticated remote device to the extranet.

17. The method of claim 16, wherein the step of authenticating the first remote device is performed by a gateway node associated with a UMTS associated with the first entity and the second entity.

18. The method of claim 17, wherein the step of connecting the authenticated first remote device to the requested second entity extranet further comprises:
directing communication signals from the first remote device through the Internet provider of the second entity.
